(19) United States
(12) Patent Application Publication
(10) Pub. No.: US 2025/0301029 A1
(43) Pub. Date: Sep. 25, 2025

(54) CONFIGURATION OF RTP HEADER EXTENSIONS HAVING THE SAME SYNTAX BUT WITH DIFFERENT SEMANTICS

(71) Applicant: QUALCOMM Incorporated, San Diego, CA (US)

(72) Inventors: Liangping Ma, San Diego, CA (US); Imed Bouazizi, Celina, TX (US)

(21) Appl. No.: 19/050,518

(22) Filed: Feb. 11, 2025

Related U.S. Application Data
(60) Provisional application No. 63/568,536, filed on Mar. 22, 2024.

(51) Int. Cl. H04L 65/65; H04L 67/131

(52) U.S. Cl. CPC H04L 65/65; H04L 67/131

(57) ABSTRACT

Example methods, devices, and computer-readable media are described. An example method includes sending or receiving, by a first computing device to or from a second computing device, information indicative of the use of a first meaning of a plurality of meanings of a Real-Time Transport Protocol (RTP) header extension syntax of an RTP header extension of an RTP packet. The method includes processing, by the first computing device, the RTP packet comprising extended reality (XR) application data based on the first meaning.

This application claims the benefit of U.S. Provisional Patent Application 63/568,536, filed Mar. 22, 2024, the entire contents of which is incorporated herein by reference.

### TECHNICAL FIELD

This disclosure relates to transport of data, such as Real-Time Transport Protocol (RTP) packets.

### BACKGROUND

Applications, such as extended reality (XR) applications, may be accessed by a client device from a server or another device over one or more networks. Information, such as XR pose information, which describes a position and orientation in space relative to the XR space, may be exchanged (e.g., sent to and/or received from) by such devices.

### SUMMARY

In general, this disclosure describes techniques for improving the communication of XR information, such as XR pose. More particularly, this disclosure describes techniques for determining XR information, such as XR pose information, of RTP header extensions without having to determine which entity is the sender of the RTP packet. These techniques may remove an ambiguity in current techniques and improve packet processing performance, for example, by avoiding having to determine which entity is the sender of the RTP packet to determine how to handle XR pose information.

In one example, a method includes: sending, by a first computing device to a second computing device, information indicative of the use of a first meaning of a plurality of meanings of a Real-Time Transport Protocol (RTP) header extension syntax of an RTP header extension of an RTP packet; and processing, by the first computing device and based on the first meaning, the RTP packet, the RTP packet comprising extended reality (XR) application data.

In another example, a computing device includes one or more memories configured to store a Real-Time Transport Protocol (RTP) packet; and one or more processors operably coupled to the memory, the one or more processors being configured to: send, to a second computing device, information indicative of the use of a first meaning of a plurality of meanings of an RTP header extension syntax of an RTP header extension of the RTP packet; and process, based on the first meaning, the RTP packet, the RTP packet comprising extended reality (XR) application data.

In one example, a method includes: receiving, by a first computing device from a second computing device, information indicative of the use of a first meaning of a plurality of meanings of a Real-Time Transport Protocol (RTP) header extension syntax of an RTP header extension of an RTP packet; and processing, by the first computing device and based on the first meaning, the RTP packet, the RTP packet comprising extended reality (XR) application data.

In another example, a computing device includes one or more memories configured to store a Real-Time Transport Protocol (RTP) packet; and one or more processors operably coupled to the memory, the one or more processors being configured to: receive, from a second computing device, information indicative of the use of a first meaning of a plurality of meanings of an RTP header extension syntax of an RTP header extension of the RTP packet; and process, based on the first meaning, the RTP packet, the RTP packet comprising extended reality (XR) application data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a block diagram illustrating an example system that implements techniques for streaming media data over a network.

FIG. 1B is a block diagram illustrating another example system that implements techniques for streaming media data over a network.

FIG. 2 is an example RTP header extension format for XR pose.

FIG. 3 is another example RTP header extension format for XR pose.

FIG. 4 is a block diagram illustrating an example system having a client device, a low-capability server, and a high-capability server.

FIG. 5 is a block diagram illustrating an example system having a low capability client device and a high capability client device.

FIG. 6 is a block diagram illustrating an example system including a client device and a server according to one or more aspects of this disclosure.

FIG. 7 is a flow diagram illustrating example configuration of RTP header extensions techniques according to one or more aspects of this disclosure.

FIG. 8 is a flow diagram illustrating another example configuration of RTP header extensions techniques according to one or more aspects of this disclosure.

### DETAILED DESCRIPTION

In general, this disclosure describes techniques for communicating a difference between semantics having a same syntax (which may also be referred to herein as format) in RTP header extensions. More particularly, this disclosure describes techniques including the use of out-of-band signaling or the use of an indication in a field of an RTP header extension to communicate a difference of intended semantics (which may also be referred to herein as “meaning”) which may otherwise appear to be the same.

For example, current RTP header extensions for XR pose information may use the same syntax or format for a request by a client device to a server (or other client device) to render the XR pose as for a response to such a request in which the RTP packet having the RTP header extension carries the XR pose or a portion thereof. Such syntax may be confusing and require additional processing by client devices, servers, or other devices to distinguish therebetween. The techniques of this disclosure address this issue of the same syntax being used to represent different semantics. While discussed primarily with respect to RTP header extensions for XR applications, such as XR pose, these techniques may be applicable to other applications where a same RTP header extension syntax is used to indicate different semantics.

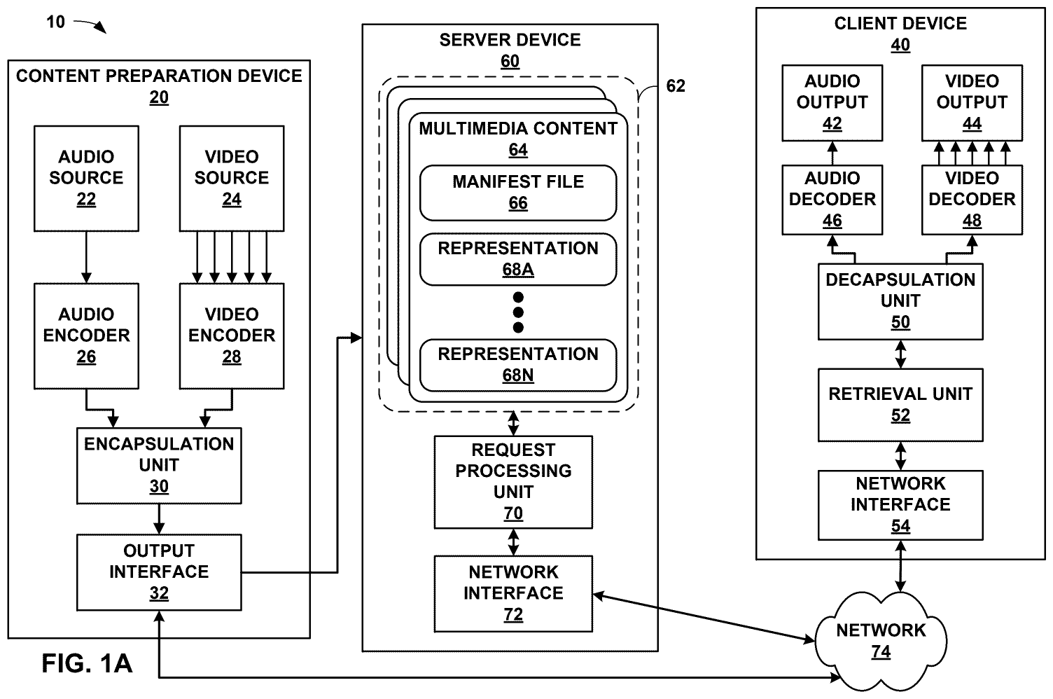

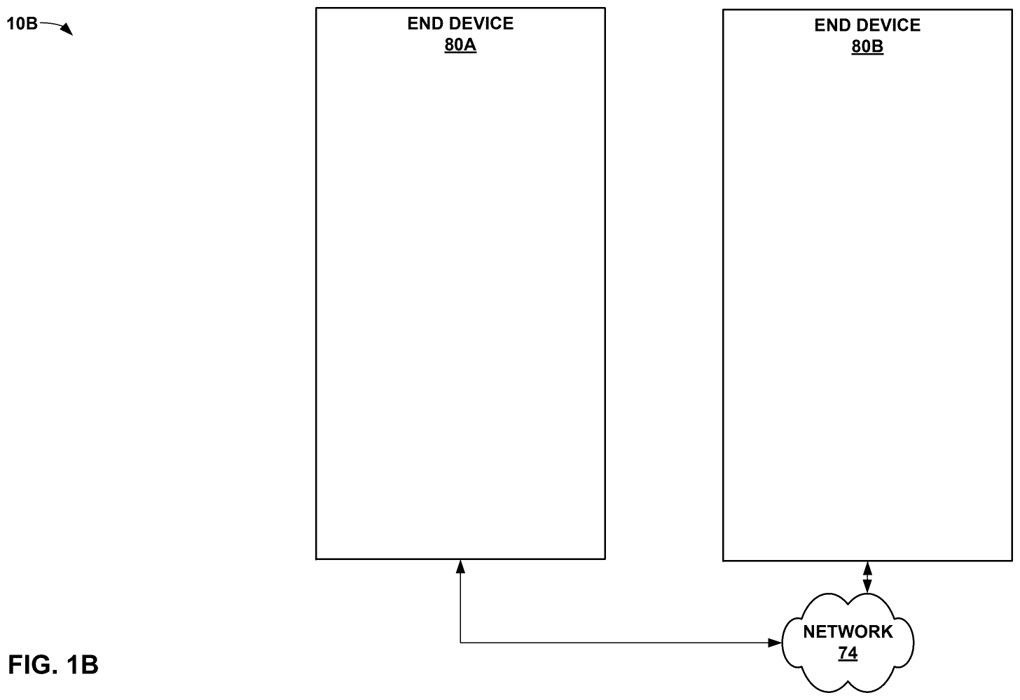

FIG. 1A is a block diagram illustrating an example system 10 that implements techniques for streaming media data over a network. In this example, system 10 includes content preparation device 20, server device 60, and client device 40. Server device 60 may be an XR application server. Client device 40 and server device 60 are communicatively coupled by network 74, which may comprise a wireless wide area network, a wireless local area network, the Internet, and/or the like. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1A, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1A, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1A, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. In some examples, request processing unit 70 may receive network requests from client device 40 in the form of RTP/SRTP packets and may deliver content, such as XR application content, to client device 40 in the form of RTP/SRTP packets.

Additionally, or alternatively, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally, or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1A, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bit rate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

The example of FIG. 1A describes the use of RTP, DASH, and HTTP-based streaming for purposes of example. However, it should be understood that other types of protocols may be used to transport media data. For example, request processing unit 70 and retrieval unit 52 may be configured to operate according to Real-time Streaming Protocol (RTSP), or the like, and use supporting protocols such as Session Description Protocol (SDP) or Session Initiation Protocol (SIP).

FIG. 1B is a block diagram illustrating another example system that implements techniques for streaming media data over a network. FIG. 1B is similar to the example of FIG. 1A, but FIG. 1B includes two end devices, rather than a client device and a server device. For example, each end device 80A and 80B of system 10B may be configured to both consume content from and provide content to the other of end device 80A and 80B. The system of FIG. 1B may implement the techniques disclosed herein.

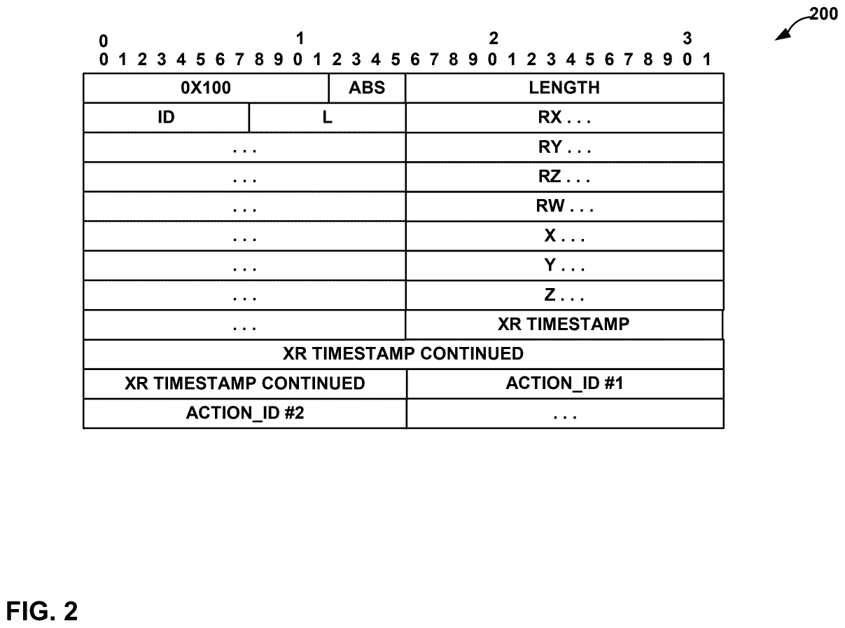

FIG. 2 is an example RTP header extension format for XR pose. RTP header extension format 200 may be a format used for signaling the RTP header extension for six degrees of freedom (6DoF) XR pose information.

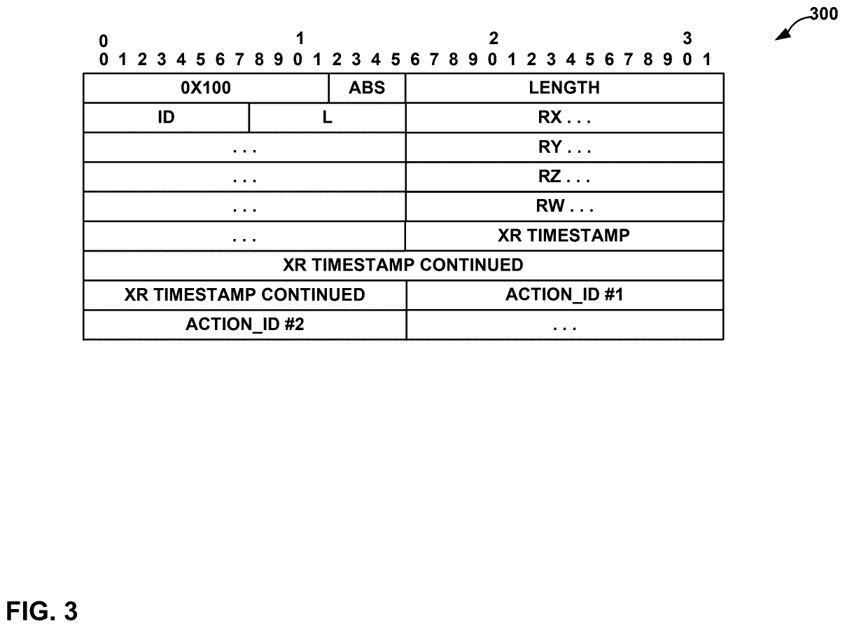

FIG. 3 is another example RTP header extension format for XR pose. RTP header extension format 300 may be a two-byte format used for signaling the RTP header extension for three degrees of freedom (3DoF) XR pose information. Note that the fields x, y, and z which were present in RTP header extension format 200 and omitted from RTP header extension format 300.

3GPP TS26.522 defined the RTP header extension format for XR pose as shown in FIGS. 2 and 3.

An RTP header extension, for example, for XR pose, has two semantics (e.g., meanings) and is thus ambiguous. This ambiguity in the semantics may be resolved by checking to determine which entity, client device 40 or server device 60, is the sender of the RTP packet that has the RTP header extension. While discussed primarily as being communicated between client device 40 and server device 60, it should be understood that the RTP packets described herein may be communicated between end device 80A and end device 80B and that end devices 80A and 80B may similarly utilize the techniques of this disclosure. It should be noted that client device 40, end device 80A, and/or end device 80B, may include an XR headset, XR glasses, XR goggles, a mobile device, such as a smartphone (e.g., user equipment or UE) and/or the like.

If the sender is client device 40, then the pose carried in the RTP header extension may be resolved to mean a “pose to render”, e.g., a pose to be rendered by server device 60 and there is no association between RTP header extension and RTP payload. However, if the sender is server device 60, then pose carried in the RTP header extension may be resolved to mean a “rendered pose”, e.g., a pose which has been rendered by server device 60 for client device 40, and the payload carries the result of the rendering.

This dependency between the semantics and the identity of the sender of the packet having the RTP header extension limits the use of the RTP header extension. For example, in more complicated scenarios than that of FIGS. 1A and 1B, basing how to interpret the meaning of information within the RTP header extension based on the identity of the sender breaks down.

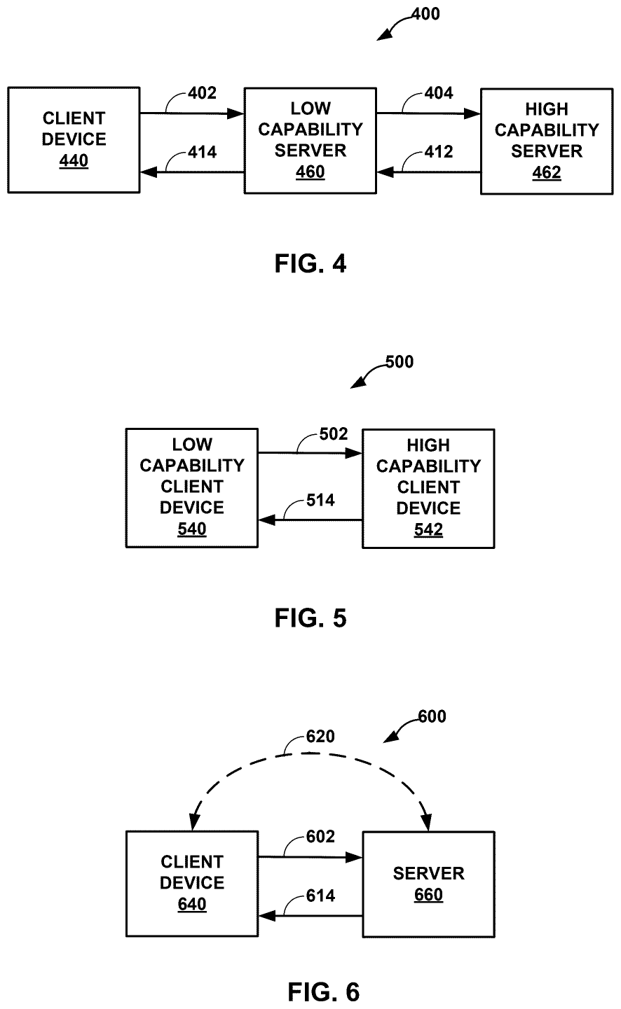

FIG. 4 is a block diagram illustrating an example system having a client device, a low-capability server, and a high-capability server. For example, a more complicated scenario may include a system 400 including client device 440, which may be an example of client device 40 of FIG. 1A. System 400 may also include a low-capability server 460 and a high-capability server 462. Low-capability server 460 and high-capability server 462 may be examples of server device 60 of FIG. 1A, but low-capability server 460 may have more limited functionality than high-capability server. In such an example, client device 440 may send an RTP packet having an RTP packet header extension including a “pose to render” 402 to low-capability server 460.

However, if the rendering workload is too high for low-capability server 460, low-capability server 460 may offload work to high-capability server 462. In such a case, low-capability server 460 may send an RTP packet 404 having an RTP packet header extension including a “pose to render” to high-capability server 462. Thus, when the rendering workload is too high for low-capability server 460, low-capability server 460 also becomes a sender of an RTP packet having an RTP packet header extension including a “pose to render.” In such a case, high-capability server 462 may, if using the identity of a device to determine the meaning of the information within the header extension, mistakenly interpret the “pose to render” as a “rendered pose.”

As such, high-capability server 462 may not perform the rendering that low-capability server 460 offloaded to high-capability server 462, because high-capability server 462 may mistakenly determine that the rendering was performed by low-capability server 460. Because of this mistake, high-capability server 462 may eventually send back to low-capability server 460 an RTP packet 412 that includes the incorrect data (e.g., unrendered data or the wrong rendered data) back to low-capability server 460. Low-capability server 460 may send an RTP packet 414 (which may or may not be the same packet as RTP packet 412) which also includes the incorrect data. In such a case, client device 440 may display the incorrect data.

FIG. 5 is a block diagram illustrating an example system having a low capability client device and a high capability client device. For example, another more complicated scenario may include a system 500 including low-capability client device 540 and high-capability client device 542, each of which may be an example of client device 40 of FIG. 1A. However, low-capability client device 540 may have less functionality or a lower capability of performing certain functions than high-capability client device 542. For example, low-capability client device 540 may be an older generation of a client device and/or a more basic model of a client device than high-capability client device 542.

For example, low-capability client device 540 may send an RTP packet 502 having an RTP header extension including a “pose to render” to high-capability client device 542. High-capability client device 514 may perform rending on the pose and send an RTP packet 502 having an RTP header extension including a “rendered pose” along with the rendering result back to low-capability client device 540. In this case, the sender of the “pose to render” and “rendered pose” are both a client device. As such, low-capability client device 540 may mistakenly determine that the rendering has not been performed. Because of this mistake, low-capability client device 540 may again send RTP packet 502 to high-capability client device 542 which may result in a looping behavior, delays, and/or the like.

This disclosure addresses the ambiguity issue regarding the meaning of syntax within RTP header extensions, such as an XR pose RTP header extension. While this disclosure primarily discusses XR pose RTP header extensions, it should be noted that other RTP header extensions may also include syntax that may have multiple semantics. For example, XR skeleton and XR gesture RTP header extensions may have similar problems. The techniques of this disclosure may apply to those RTP header extensions and/or any other header extensions where one syntax may have more than one semantic or meaning.

FIG. 6 is a block diagram illustrating an example system including a client device and a server according to one or more aspects of this disclosure. It should be noted that system 600 of FIG. 6 may include additional devices, including devices such as those described with respect to FIGS. 4 and 5. In some examples, for an RTP header extension that has multiple semantics/meanings, such as (1) “pose to render” vs “rendered pose”, (2) “skeleton to render” vs “rendered skeleton”, (3) “gesture to render” vs “rendered gesture”, the semantics may be indicated using out-of-band signaling (e.g., via SDP signaling). For example, client device 640 (which may be an example of client device 40 of FIG. 1A) and server 660 (which may be an example of server device 60 of FIG. 1A) may communicate information regarding the semantics associated with an RTP header extension via out-of-band signaling 620. Therefore, rather than resolving the ambiguity by determining the intent of the information included in the RTP header extension based on which device is the sending device, client device 640 and server 660 may actually communicate the proper semantics for the RTP header extension via out-of-band signaling 620.

In some examples, out-of-band signaling 620 may include session description protocol (SDP) signaling. In some examples, client device 640 and server 660 may use augmented Backus-Naur form (ABNF) syntax for an “extmap” attribute in the session description protocol (SDP) signaling. In a first example, client device 640 and server 660 may use two different extension names for XR pose. For example, for an XR pose rendered by the sender, client device 640 and server 660 may use extensionname=“urn:3gpp:xr-pose-rendered” and for an XR pose that the sender expects the receiver to render, client device 640 and server 660 may use extensionname=“urn:3gpp:xr-pose-to-render.”

In a second example, client device 640 and server 660 may use an option in the extension attributes to communicate information regarding the semantics associated with an RTP header extension. In a first example, extensionname=“urn:3gpp:xr-pose” and extensionattributes=“3DOF”/“6DOF”[“to-render”/“rendered”][“media:” 1*(SP token)], where extensionattributes may include “to-render” or “rendered” information. In this example, the extension attribute “to-render” means that the sender expects the XR pose to be rendered by the receiver, and “rendered” means that the sender has rendered the XR pose carried in the RTP header extension and the RTP payload is associated with the result of the rendering. When [“to-render”/“rendered”] is absent, e.g., neither “to-render” nor “rendered” is present, a default semantics (e.g., “rendered”) may be assigned. In a second example, extensionname=“urn:3gpp:xr-pose” and extensionattributes=“3DOF”/“6DOF” (“to-render”/“rendered”) [“media:” 1*(SP token)]. The second example differs from the first example in the use of ( ) instead of [ ] around “to-render”/“rendered” to specify that the presence of the field is mandatory.

In another example, for an RTP header extension that has multiple semantics/meanings, client device 640 and server 660 may indicate the semantics in a field in the RTP header extension itself. For example, the indication may be a one-bit flag in an RTP header extension of RTP packet 602 and in an RTP header extension of RTP packet 614 to distinguish between two different semantics.

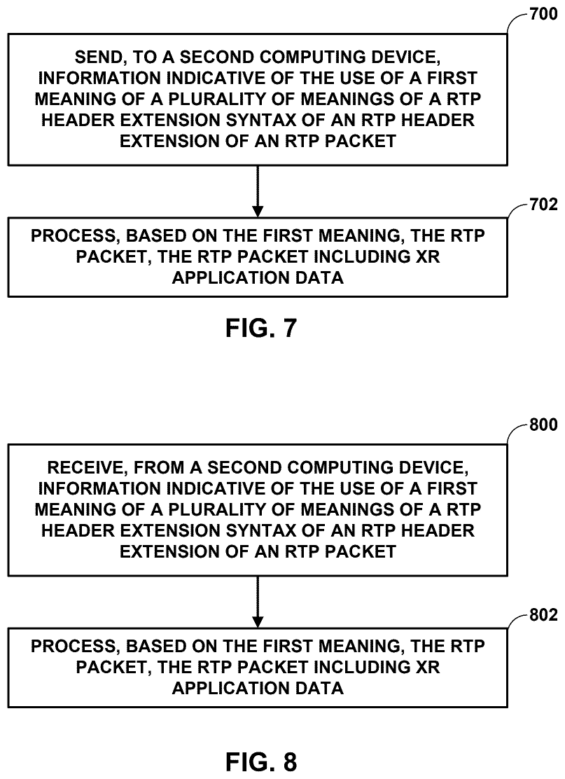

FIG. 7 is a flow diagram illustrating example configuration of RTP header extensions techniques according to one or more aspects of this disclosure. The techniques of FIG. 7 are described with respect to FIG. 1A although them may be performed by a device capable of doing so, including devices of FIG. 1B or FIGS. 4-6.

Server device 60 or client device 40 may send, to a second computing device, information indicative of the use of a first meaning of a plurality of meanings of a Real-Time Transport Protocol (RTP) header extension syntax of an RTP header extension of an RTP packet (700). For example, server device 60 may send to client device 40 and/or client device 40 may send to server device 60 to indicate that the RTP header extension syntax of a particular RTP header extension should be interpreted according to a particular meaning. The RTP header extension syntax may be otherwise interpretable according to more than one meaning.

Server device 60 or client device 40 may process, based on the first meaning, the RTP packet, the RTP packet including comprising extended reality (XR) application data (702). For example, server device 60 or client device 40 may process the RTP packet in accordance with the particular meaning.

In some examples, as part of sending the information, server device 60 and/or client device 40 may send the information out-of-band. In some examples, server device 60 and/or client device 40 signal the information via session description protocol.

In some examples, as part of sending the information out-of-band, server device 60 and/or client device 40 may send a first extension name, wherein the first extension name comprises the information indicative of the use of the first meaning of the RTP header extension syntax. In some examples, the first extension name is chosen from a plurality of extension names, each of the plurality of extension names comprising information indicative of a use of a respective meaning. In some examples, as part of sending the information out-of-band, server device 60 and/or client device 40 may send the information in an extension attribute.

In some examples, as part of sending the information, server device 60 and/or client device 40 may send the meaning in the RTP header extension. In some examples, as part of sending the meaning in the RTP header extension, server device 60 and/or client device 40 may set or read a flag in the RTP header extension. In some examples, the flag is one bit in length.

In some examples, the first computing device includes at least one of a first server or a first client device and wherein the second computing device includes at least one of a second server or a second client device.

In some examples, the RTP header extension is indicative of the RTP packet comprising XR pose data. In some examples, the first meaning includes pose to render and wherein processing the RTP packet includes rendering a pose based on the XR application data. For example, server device 60 or client device 40 may render 3-dimensional XR application data into 2-dimensional XR application data according to the pose, which may be carried in the payload of the RTP packet (e.g., in the XR application data). In some examples, the first meaning includes rendered pose and wherein processing the RTP packet includes using the XR application data as a rendered pose. For example, the payload of the RTP packet may include rendered 2-dimensional data and the receiving device may display the rendered 2-dimensional data.

FIG. 8 is a flow diagram illustrating another example configuration of RTP header extensions techniques according to one or more aspects of this disclosure. The techniques of FIG. 8 are described with respect to FIG. 1A although them may be performed by a device capable of doing so, including devices of FIG. 1B or FIGS. 4-6.

Server device 60 or client device 40 may receive, from a second computing device, information indicative of the use of a first meaning of a plurality of meanings of a Real-Time Transport Protocol (RTP) header extension syntax of an RTP header extension of an RTP packet (800). For example, server device 60 may receive from client device 40 and/or client device 40 may receive from server device 60 to indicate that the RTP header extension syntax of a particular RTP header extension should be interpreted according to a particular meaning. The RTP header extension syntax may be otherwise interpretable according to more than one meaning.

Server device 60 or client device 40 may process, based on the first meaning, the RTP packet, the RTP packet including comprising extended reality (XR) application data (802). For example, server device 60 or client device 40 may process the RTP packet in accordance with the particular meaning.

In some examples, as part of receiving the information, server device 60 and/or client device 40 may receive the information out-of-band. In some examples, server device 60 and/or client device 40 signal the information via session description protocol.

In some examples, as part of receiving the information out-of-band, server device 60 and/or client device 40 may receive a first extension name, wherein the first extension name comprises the information indicative of the use of the first meaning of the RTP header extension syntax. In some examples, the first extension name is chosen from a plurality of extension names, each of the plurality of extension names comprising information indicative of a use of a respective meaning. In some examples, as part of receiving the information out-of-band, server device 60 and/or client device 40 may receive the information in an extension attribute.

In some examples, as part of receiving the information, server device 60 and/or client device 40 may receive the meaning in the RTP header extension. In some examples, as part of receiving the meaning in the RTP header extension, server device 60 and/or client device 40 may set or read a flag in the RTP header extension. In some examples, the flag is one bit in length.

In some examples, the first computing device includes at least one of a first server or a first client device and wherein the second computing device includes at least one of a second server or a second client device.

In some examples, the RTP header extension is indicative of the RTP packet comprising XR pose data. In some examples, the first meaning includes pose to render and wherein processing the RTP packet includes rendering a pose based on the XR application data. For example, server device 60 or client device 40 may render 3-dimensional XR application data into 2-dimensional XR application data according to the pose, which may be carried in the payload of the RTP packet (e.g., in the XR application data). In some examples, the first meaning includes rendered pose and wherein processing the RTP packet includes using the XR application data as a rendered pose. For example, the payload of the RTP packet may include rendered 2-dimensional data and the receiving device may display the rendered 2-dimensional data.

Various examples of the techniques of this disclosure are summarized in the following clauses:

Clause 1A. A method comprising: communicating, by a first computing device with a second computing device, information regarding a first meaning of at least two meanings of a Real-Time Transport Protocol (RTP) header extension syntax; and processing, by the first computing device, data of an extended reality (XR) application based on the first meaning.

Clause 2A. The method of clause 1A, wherein communicating the information comprises communicating the information out-of-band.

Clause 3A. The method of clause 2A, wherein communicating the information out-of-band comprises signaling the information via session description protocol.

Clause 4A. The method of any of clauses 2A-3A, wherein communicating the information out-of-band comprises communicating a first extension name, wherein the first extension name comprises the information regarding the first meaning.

Clause 5A. The method of clause 4A, wherein the first extension name is chosen from a plurality of extension names, each of the plurality of extension names comprising information regarding a respective meaning.

Clause 6A. The method of any of clauses 2A-3A, wherein communicating the information out-of-band comprises communicating the information in an extension attribute.

Clause 7A. The method of clause 1A, wherein communicating the information comprises indicating the meaning in the RTP header extension.

Clause 8A. The method of clause 7A, wherein indicating the meaning in the RTP header extension comprises setting a flag in the RTP header extension.

Clause 9A. The method of clause 8A, wherein the flag is one bit in length.

Clause 10A. The method of any of clauses 1A-9A, wherein the RTP header extension is an XR pose header extension.

Clause 11A. A computing device, comprising: one or more memories configured to store an RTP packet; and one or more processors coupled to the memory, the one or more processors being configured to perform any of the methods of clauses 1A-10A.

Clause 12A. The computing device of clause 11A, wherein the computing device comprises a mobile device or a server.

Clause 13A. A computing device comprising at least one means for performing any of the methods of clauses 1A-10A.

Clause 14A. Computer-readable storage media storing instructions, which, when executed, cause one or more processors to perform any of the methods of clauses 1A-10A.

Clause 1B. A method comprising: sending, by a first computing device to a second computing device, information indicative of the use of a first meaning of a plurality of meanings of a Real-Time Transport Protocol (RTP) header extension syntax of an RTP header extension of an RTP packet; and processing, by the first computing device and based on the first meaning, the RTP packet, the RTP packet comprising extended reality (XR) application data.

Clause 2B. The method of clause 1B, wherein sending the information comprises sending the information out-of-band.

Clause 3B. The method of clause 2B, wherein sending the information out-of-band comprises signaling the information via session description protocol.

Clause 4B. The method of any of clauses 2B-3B, wherein sending the information out-of-band comprises sending a first extension name, wherein the first extension name comprises the information indicative of the use of the first meaning of the RTP header extension syntax.

Clause 5B. The method of clause 4B, wherein the first extension name is chosen from a plurality of extension names, each of the plurality of extension names comprising information indicative of a use of a respective meaning.

Clause 6B. The method of any of clauses 2B-3B, wherein sending the information out-of-band comprises sending the information in an extension attribute.

Clause 7B. The method of clause 1B, wherein sending the information comprises sending the first meaning in the RTP header extension.

Clause 8B. The method of clause 7B, wherein sending the first meaning in the RTP header extension comprises setting or reading a flag in the RTP header extension.

Clause 9B. The method of clause 8B, wherein the flag is one bit in length.

Clause 10B. The method of any of clauses 1B-9B, wherein the first computing device comprises at least one of a first server or a first client device and wherein the second computing device comprises at least one of a second server or a second client device.

Clause 11B. The method of any of clauses 1B-10B, wherein the RTP header extension is indicative of the RTP packet comprising XR pose data.

Clause 12B. The method of clause 11B, wherein the first meaning comprises pose to render, and wherein processing the RTP packet comprises rendering a pose based on the XR application data.

Clause 13B. The method of clause 11B, wherein the first meaning comprises rendered pose and wherein processing the RTP packet comprises using the XR application data as a rendered pose.

Clause 14B. A first computing device, comprising: one or more memories configured to store a Real-Time Transport Protocol (RTP) packet; and one or more processors operably coupled to the memory, the one or more processors being configured to: send, to a second computing device, information indicative of the use of a first meaning of a plurality of meanings of an RTP header extension syntax of an RTP header extension of the RTP packet; and process, based on the first meaning, the RTP packet, the RTP packet comprising extended reality (XR) application data.

Clause 15B. The first computing device of clause 14B, wherein as part of sending the information, the one or more processors are configured to send the information out-of-band.

Clause 16B. A method comprising: receiving, by a first computing device from a second computing device, information indicative of the use of a first meaning of a plurality of meanings of a Real-Time Transport Protocol (RTP) header extension syntax of an RTP header extension of an RTP packet; and processing, by the first computing device and based on the first meaning, the RTP packet, the RTP packet comprising extended reality (XR) application data.

Clause 17B. The method of clause 16B, wherein receiving the information comprises receiving the information out-of-band.

Clause 18B. The method of clause 17B, wherein receiving the information out-of-band comprises signaling the information via session description protocol.

Clause 19B. The method of any of clauses 17B-18B, wherein receiving the information out-of-band comprises receiving a first extension name, wherein the first extension name comprises the information indicative of the use of the first meaning of the RTP header extension syntax.

Clause 20B. The method of clause 19B, wherein the first extension name is chosen from a plurality of extension names, each of the plurality of extension names comprising information indicative of a use of a respective meaning.

Clause 21B. The method of any of clauses 17B-18B, wherein receiving the information out-of-band comprises receiving the information in an extension attribute.

Clause 22B. The method of clause 16B, wherein receiving the information comprises receiving the first meaning in the RTP header extension.

Clause 23B. The method of clause 22B, wherein receiving the first meaning in the RTP header extension comprises setting or reading a flag in the RTP header extension.

Clause 24B. The method of clause 23B, wherein the flag is one bit in length.

Clause 25B. The method of any of clauses 16B-24B, wherein the first computing device comprises at least one of a first server or a first client device and wherein the second computing device comprises at least one of a second server or a second client device.

Clause 26B. The method of any of clauses 16B-25B, wherein the RTP header extension is indicative of the RTP packet comprising XR pose data.

Clause 27B. The method of clause 26B, wherein the first meaning comprises pose to render, and wherein processing the RTP packet comprises rendering a pose based on the XR application data.

Clause 28B. The method of clause 26B, wherein the first meaning comprises rendered pose and wherein processing the RTP packet comprises using the XR application data as a rendered pose.

Clause 29B. A first computing device, comprising: one or more memories configured to store a Real-Time Transport Protocol (RTP) packet; and one or more processors operably coupled to the memory, the one or more processors being configured to: receive, from a second computing device, information indicative of the use of a first meaning of a plurality of meanings of an RTP header extension syntax of an RTP header extension of the RTP packet; and process, based on the first meaning, the RTP packet, the RTP packet comprising extended reality (XR) application data.

Clause 30B. The first computing device of clause 29B, wherein as part of receiving the information, the one or more processors are configured to receive the information out-of-band.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
sending, by a first computing device to a second computing device, information indicative of a use of a first meaning of a plurality of meanings of a Real-Time Transport Protocol (RTP) header extension syntax of an RTP header extension of an RTP packet; and
processing, by the first computing device and based on the first meaning, the RTP packet, the RTP packet comprising extended reality (XR) application data.

2. The method of claim 1, wherein sending the information comprises sending the information out-of-band.

3. The method of claim 2, wherein sending the information out-of-band comprises signaling the information via session description protocol.

4. The method of claim 2, wherein sending the information out-of-band comprises sending a first extension name, wherein the first extension name comprises the information indicative of the use of the first meaning of the RTP header extension syntax.

5. The method of claim 4, wherein the first extension name is chosen from a plurality of extension names, each of the plurality of extension names comprising information indicative of a use of a respective meaning.

6. The method of claim 2, wherein sending the information out-of-band comprises sending the information in an extension attribute.

7. The method of claim 1, wherein sending the information comprises sending the first meaning in the RTP header extension.

8. The method of claim 7, wherein sending the first meaning in the RTP header extension comprises setting or reading a flag in the RTP header extension.

9. The method of claim 8, wherein the flag is one bit in length.

10. The method of claim 1, wherein the first computing device comprises at least one of a first server or a first client device and wherein the second computing device comprises at least one of a second server or a second client device.

11. The method of claim 1, wherein the RTP header extension is indicative of the RTP packet comprising XR pose data.

12. The method of claim 11, wherein the first meaning comprises pose to render, and wherein processing the RTP packet comprises rendering a pose based on the XR application data.

13. The method of claim 11, wherein the first meaning comprises rendered pose and wherein processing the RTP packet comprises using the XR application data as a rendered pose.

14. A first computing device, comprising:
one or more memories configured to store a Real-Time Transport Protocol (RTP) packet; and
one or more processors operably coupled to the memory, the one or more processors being configured to:
send, to a second computing device, information indicative of a use of a first meaning of a plurality of meanings of an RTP header extension syntax of an RTP header extension of the RTP packet; and
process, based on the first meaning, the RTP packet, the RTP packet comprising extended reality (XR) application data.

15. The first computing device of claim 14, wherein as part of sending the information, the one or more processors are configured to send the information out-of-band.

16. A method comprising:
receiving, by a first computing device from a second computing device, information indicative of a use of a first meaning of a plurality of meanings of a Real-Time Transport Protocol (RTP) header extension syntax of an RTP header extension of an RTP packet; and
processing, by the first computing device and based on the first meaning, the RTP packet, the RTP packet comprising extended reality (XR) application data.

17. The method of claim 16, wherein receiving the information comprises receiving the information out-of-band.

18. The method of claim 17, wherein receiving the information out-of-band comprises signaling the information via session description protocol.

19. The method of claim 17, wherein receiving the information out-of-band comprises receiving a first extension name, wherein the first extension name comprises the information indicative of the use of the first meaning of the RTP header extension syntax.

20. The method of claim 19, wherein the first extension name is chosen from a plurality of extension names, each of the plurality of extension names comprising information indicative of a use of a respective meaning.

21. The method of claim 17, wherein receiving the information out-of-band comprises receiving the information in an extension attribute.

22. The method of claim 16, wherein receiving the information comprises receiving the first meaning in the RTP header extension.

23. The method of claim 22, wherein receiving the first meaning in the RTP header extension comprises setting or reading a flag in the RTP header extension.

24. The method of claim 23, wherein the flag is one bit in length.

25. The method of claim 16, wherein the first computing device comprises at least one of a first server or a first client device and wherein the second computing device comprises at least one of a second server or a second client device.

26. The method of claim 16, wherein the RTP header extension is indicative of the RTP packet comprising XR pose data.

27. The method of claim 26, wherein the first meaning comprises pose to render, and wherein processing the RTP packet comprises rendering a pose based on the XR application data.

28. The method of claim 26, wherein the first meaning comprises rendered pose and wherein processing the RTP packet comprises using the XR application data as a rendered pose.

29. A first computing device, comprising:
one or more memories configured to store a Real-Time Transport Protocol (RTP) packet; and
one or more processors operably coupled to the memory, the one or more processors being configured to:
receive, from a second computing device, information indicative of a use of a first meaning of a plurality of meanings of an RTP header extension syntax of an RTP header extension of the RTP packet; and
process, based on the first meaning, the RTP packet, the RTP packet comprising extended reality (XR) application data.

30. The first computing device of claim 29, wherein as part of receiving the information, the one or more processors are configured to receive the information out-of-band.
